(19) United States
(12) Patent Application Publication
(10) Pub. No.: US 2008/0185458 A1
(43) Pub. Date: Aug. 7, 2008

(54) Shower head cover fixture

(76) Inventor: Alan E. Holbrook, Dallas, TX (US)

Correspondence Address: Alan E. Holbrook Sr., 9407 Spring Branch, Dallas, TX, 75238, US

(21) Appl. No.: 11/702,253

(22) Filed: Feb. 6, 2007

(51) Int. Cl. B05B 1/26

(52) U.S. Cl. 239/211

(57) ABSTRACT

A shower head cover fixture consists of a mostly cylindrical free formed elongated device of varying size and design which eclipses and covers a shower head water sprayer. Said shower head covering fixture having and aperture at entrance of sufficient size to accommodate the insertion of a verity of shower head sprays. The paralleling opposite end of fixture having an opening of adequate size allowing the threaded connection of piping therethrough connecting a shower head thereto an existing shower arm in a shower inclosure. The fixture may be of translucent or solid manufacture composed of a variety of materials. The cover for shower heads fixture does not influence the operation of a shower head, rather it's purpose to accentuate the decorative appearance of the showering system . . . thereby enhancing and complimenting the nondescript array of shower head systems in common use today.

### BACKGROUND OF THE INVENTION

The present invention relates to the field of accessories used in shower bathing. The covering of new and existing shower heads of varying size and design. Allowing the inclosure and attachment of a shower head within a shower cover fixture being connected therethreough to a shower arm within a showering enclosure. Shower head cover fixture while not impeding or affecting the action or of a shower head contributes to the stability of connection to shower arm. The present invention utilizes a water proof or water resistant material and may be manufactured in a variety of materials commonly used in todays market, shape and sizes being selected according to size of shower heads. In operation the user inserts a conventional shower head into the enveloping open end of a shower cover fixture, threadedly connecting the shower head thereto piping extending therethrough the circular open opposite end of shower head cover fixture to an existing shower arm within a shower bathing enclosure. A conventional shower head is fixed directly to a shower arm and stands alone, as a result, the conventional shower heads in use are rather limited in design achieving varying spraying patterns only and lacks the embellishment a shower head cover fixture bestows on them Thus the manufacture of certain designs, sizing, use of varying piping with limited color choices using showering fixtures heretofore devised and utilized in the basic obvious structural designs encompassed by the crowded prior art which has been developed for the fulfillment of countless objectives and requirements in present use by shower heads. While these devices fulfill their respective, particular objectives and uses, they do not attain the flexibility of shape, variety of color, design and choice of material accomplished with the use of an added shower head cover fixture. The inventive device consists of an elongated one piece generally circular shape, having a larger open end of adequate size allowing the insertion of a conventional; water shower spray head of varying size and design. The opposite distal end being partially inclosed of adequate length therefrom, allowing the threaded connection of a diverse variety of shower heads.

The center positioned opening inclosed end of said device being of sufficient radius allowing the insertion therethrough of a threaded pipe connecting to an existing shower arm within a shower enclosure thereby allowing the flow of fresh water through piping connected to shower head encompassed within a shower head cover fixture. In these respects, the shower head cover fixture according to the present invention substantially departs from the conventional concepts and designs of the prior art. The shower head cover fixture accomplishes a simple workable aesthetic design enabling its manufacture and installation at low cost and assures reliable simple operation

### BRIEF DESCRIPTION OF THE DRAWINGS

The invention will be better understood and will become more apparent when consideration is given to the following detailed description thereof. such description makes reference to the drawings herein. And accordingly a better understanding of the invention and the multiple uses are intended by referenced in the drawings which are considered as primarily representative and not to be therefore considered restrictive in nature.

FIG. 1, is a perspective frontal side view of present shower head cover fixture for shower heads invention.

FIG. 2, is a perspective rear horizontal partial side view of present shower head cover fixture invention detailing cylindrical rear opening

FIG. 3, is a detailed front view of the present shower head cover fixture invention.

FIG. 4, is a sectional side view of present invention detailing rear circular opining.

FIG. 5, is a detailed rear view of present shower head cover fixture invention.

FIG. 6, is a side sectional view of shower cover showing a shower head in place encompassed within shower cover thereby being attached to existing shower arm.

FIG. 7, is a side sectional view illustrating flexibility of shower cover shape while maintaining original piping connection thereto of shower head with shower arm.

### DETAILED DESCRIPTION OF THE INVENTION

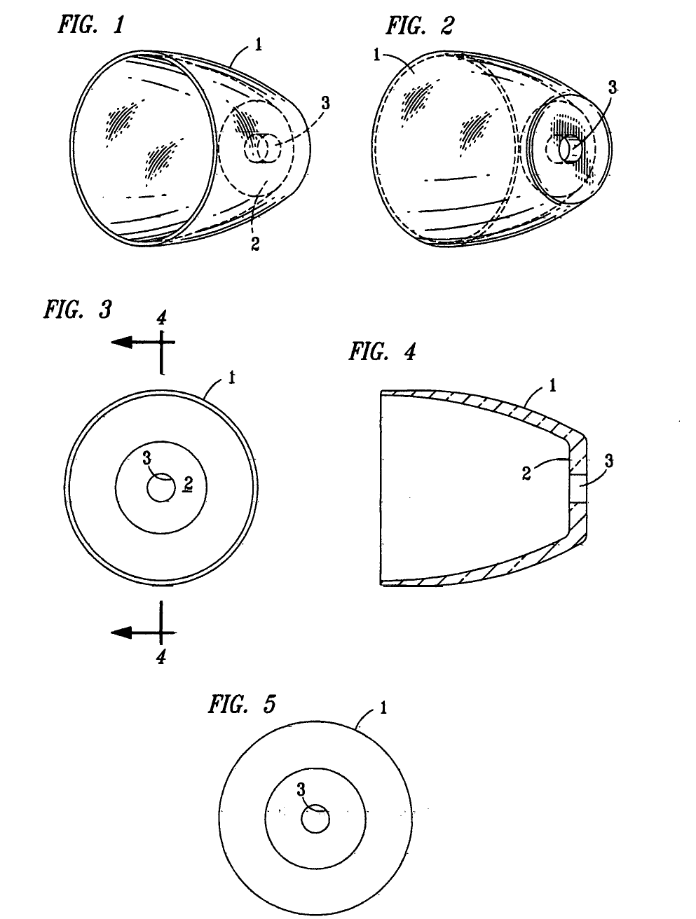

More specifically referring to the drawings, FIGS. 1 through 7 depict the embodiment of the applicant's invention. FIG. 1 For reference purposes showing shower head cover fixture for shower heads depicted in translucent material 1 enabling the device to be manufactured of both solid or transparent material accommodating a diversity of shower head designs, the body of the present invention 1 also details the cylindrical shape of the shower cover enabling its encirclement of a shower head, which being attached at rear of shower cover 2 in threaded attachment to piping extending through cylindrical outlet 3 of a shower cover connecting therethrough to a shower arm. FIG. 2 of the drawings being rear horizontal pictorial view illustrating typically cylindrical shower head cover, Exemplifying the larger aperture of frontal opening 1 of present invention, allowing the encompassing therein of a variety of shower head designs which are thereby inserted within the cover for shower heads fixture being connected therethrough 3 by threaded assembly with shower arm extended from wall of an existing shower inclosure.

Shower head cover fixture as shown in frontal view FIG. 3 emphasizes the circular outer aperture 1 which may be of varying size and design enhancing appearance of shower head being attached therethrough circular opening 3 at distal end 2 of shower cover.

FIG. 4 Side horizontal view of a shower head cover fixture illustrates the cylindrical encompassing outer wall 1 of the preferred embodiment detailing circular rear wall 2 substantially enclosed therein culminating in smaller aperture of outlet 3 allowing the fluid connection of piping to shower arm extending from existing shower wall.

FIG. 5 A rear horizontal view of cover for shower heads fixture showing 1 circular outer extremity denoting encompassing ability of a shower cover in relation to the variety of design and size of shower heads it is designed to cover, outlet 3 at rear view illustrates opening of adequate circumference thereby accepting piping used in connection of shower heads therethrough to existing shower spaying arm.

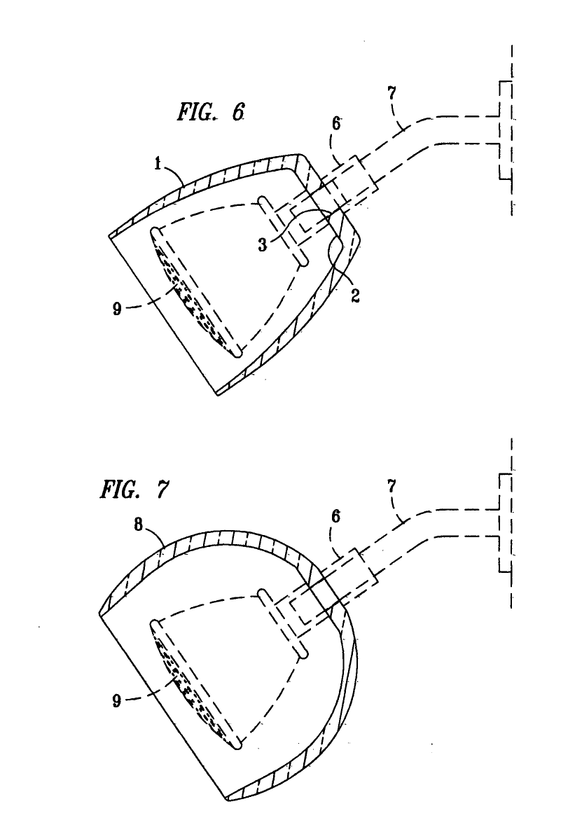

FIG. 6 shows total embodiment of cover for shower head fixtures configuration and design 1 being cylindrical in shape capable of varying adaptable circumferences of outer periphery while detailing rear wall enclosure 2, circular outlet 3 allowing threaded connection therethrough of connecting piping 6 attached thereto shower arm 7 extending from existing shower enclosure culminating with the adjustable mounting of shower head 9, typifying the verity in size and design of shower heads being enhanced by the use of the cover for shower heads fixture as shown in FIG. 7, an alternate embodiment not limited in shape or size of outer periphery 8 while maintaining attachment therewith existing shower arm 7 being threadedly connected therethrough piping 6 completing assembly with shower head 9.

The foregoing description is merely considered as an illustration of the principles of the invention. Since numerous modifications and changes such as dimensions, sizes, materials, function and manor of operation, and assembly and use will readily occur to those skilled In the art, it is not desired to limit the invention to the exact construction and operation shown and described. Accordingly, all suitable modifications and equivalents may be resorted to, falling within the scope of the invention.

### SUMMARY OF THE INVENTION

It is therefor, the primary purpose of the present invention to provide a shower head cover fixture for new or existing shower heads being connected thereto a shower arm extending from the wall of a showering inclosure wherein the shower head cover fixture encompasses the body of a shower head while not limiting the spraying function of the shower head, enables the use of a verity of shower head designs. The shower head cover fixture being separate from a shower head is not limited to flexible of size shape or composition of material as it is designed to enhance the common shower head designs now present in the prior art.

A typical modern stall-shower or tub-shower installation consists of a single spray head of varying size utilizing multiple spray setting controlling the intensity of water being sprayed therefrom. The general design and intention of the present invention is its unique method of manufacture utilizing solid or transparent materials thereby successfully maximizing the appearance of the common shower head in use today.

To attain this, the present invention generally comprises the fabrication of a cylindrically shaped device of predetermined material, size and design to accommodate the selected common shower head which it will encompass, entailing the larger circular open end of device through which shower head will be inserted and threadly connected therethrough rear circular opening being of adequate length and circumference to accommodate water supply piping extending from shower arm fluidly connected within an existing shower enclosure, said device thereby providing esthetic appearance and eloquence to ordinary shower heads at reasonable manufacturing expense. These objects of the invention, along with various features which characterize the invention, are pointed out with particularity in the accompanying drawings and claims eluded to and forming a part of this disclosure.

What is claimed is:

1. A shower head cover fixture, for use in covering, encompassing and enveloping a shower head which is attached to a shower arm extending from a fresh water outlet in the wall of a shower inclosure, said fixture comprising a mostly circular cylindrical shape device which encircles a shower head thereby covering the sides and rear portions of shower head while allowing unobstructed flow of water spraying from shower head nozzle, said shower head cover fixture design being capable of accommodating a variety of interchangeable shower head configurations connected by way of piping extending through shower cover fixture being fluidly attached to a shower arm protruding from wall of a shower enclosure

2. The shower head cover fixture of claim 1, wherein manufacturing design allows the flexibility of size adaptable to shower head structure being covered.

3. The shower head cover fixture of claim 1, wherein: selection of material allows the choice of solid or translucent manufacture

4. The shower head cover fixture of claim 3, wherein: the use of metal, glass or plastic may be interchangeable fabricated into the manufacturing process.

5. The shower head cover fixture of claim 3. wherein flexibility of shape and design may be determined by choice of material.

6. The shower head cover fixture of claim 1. wherein: shower head connection within shower cover fixture permits flexibility of adjustment horizontally or vertically thereby controlling direction of water spray from a shower head nozzle.

7. The shower head cover fixture of claim 4. wherein: interchangeable fabricating capability further enhances the aesthetic design, efficiently boosting the interest and function of present invention in practical use.

8. The shower head cover fixture of claim 4. wherein: its flexibility of amplitude accentuates and italicizes the common shower heads only purpose of spraying water in varying patterns onto a bather, thereby culminating in the connection of shower head via shower arm in fluid attachment thereto wall of shower enclosure.
